(19) United States
(12) Patent Application Publication
(10) Pub. No.: US 2007/0162605 A1
(43) Pub. Date: Jul. 12, 2007

(54) Distributed instant messaging

(76) Inventors: Nanchariah R. Chalasani, Fairfax, VA (US); Rohit D. Kelapure, Durham, NC (US); Balaji Krishnamachari-Sampath, Morrisville, NC (US)

Correspondence Address: DILLON & YUDELL LLP, 8911 N. CAPITAL OF TEXAS HWY., SUITE 2110, AUSTIN, TX, 78759, US

(21) Appl. No.: 11/326,990

(22) Filed: Jan. 7, 2006

(51) Int. Cl. G06F 15/16

(52) U.S. Cl. 709/227

(57) ABSTRACT

A method, apparatus and computer-usable medium for the steps of (1) establishing a first Instant messaging (IM) session with a first user login identifier (ID) on a first client device with a first network routing address; and, when a request to establish a next IM session with the same first user login ID is received from a second client device while the first IM session is active, dynamically enabling a seamless continuation of the first IM session on the second client device. The above steps are completed within a computing environment having multiple client devices, each configured with an IM utility

### BACKGROUND OF THE INVENTION

The present invention relates in general to the field of computers and similar technologies, and in particular to software utilized in this field.

Current instant messaging solutions do not allow for multiple IM clients to be simultaneously registered/open for the same user (i.e., sharing of an instant messaging (IM) session among IM clients on multiple machines). For instance, if a user is running a set of complex simulations using tens (or hundreds) of machines in the lab, and the user wishes to maintain a communication session via IM with a contact in his IM buddy list, the user has to continually log in from the different machines that he is working on, while simultaneously logging off the IM client on the previous machine. Each new login from a different machine results in a loss of state associated with the IM session, since session state is not persisted or transferred. Therefore the same user cannot be logged in from multiple different machines without logging out and in, thereby altering/loosing the session state at each logging.

### SUMMARY OF THE INVENTION

The present invention includes, but is not limited to, a method, apparatus and computer-usable medium for the steps of (1) establishing a first Instant messaging (IM) session with a first user login identifier (ID) on a first client device with a first network routing address; and, when a request to establish a next IM session with the same first user login ID is received from a second client device while the first IM session is active, dynamically enabling a seamless continuation of the first IM session on the second client device. The above steps are completed within a computing environment having multiple client devices, each configured with an IM utility.

The above, as well as additional purposes, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings, where:

FIG. 1 is a block diagram representation of a data processing system configured to enable various features of the invention, according to one embodiment of the invention;

FIG. 2 is a network diagram illustrating multiple user machines (clients) by which seamless login to an ongoing IM session is enabled according to one embodiment of the invention;

FIGS. 3A-3B provide sequence diagrams illustrating communication processes by which seamless connection of IM sessions from a primary and secondary client is implemented, in accordance with two alternate embodiments of the invention;

FIGS. 4A-4B are flow charts of the processes by which seamless connection and continuation of an IM session from primary to secondary clients is enabled, in accordance with embodiments of the invention;

FIGS. 5A-C show a flow-chart of steps taken to deploy in a Virtual Private Network (VPN) software that is capable of executing the steps shown and described in FIGS. 3A-4B;

FIGS. 6A-B provide a flow-chart showing steps taken to integrate into a computer system software that is capable of executing the steps shown and described in FIGS. 3A-4B;

FIGS. 7A-B provide a flow-chart showing steps taken to execute the steps shown and described in FIGS. 3A-4B using an on-demand service provider; and

FIGS. 8A-B show a flow-chart of steps taken to deploy software capable of executing the steps shown and described in FIGS. 3A-4B.

### DETAILED DESCRIPTION OF THE PREFERRED EMBODIMENT

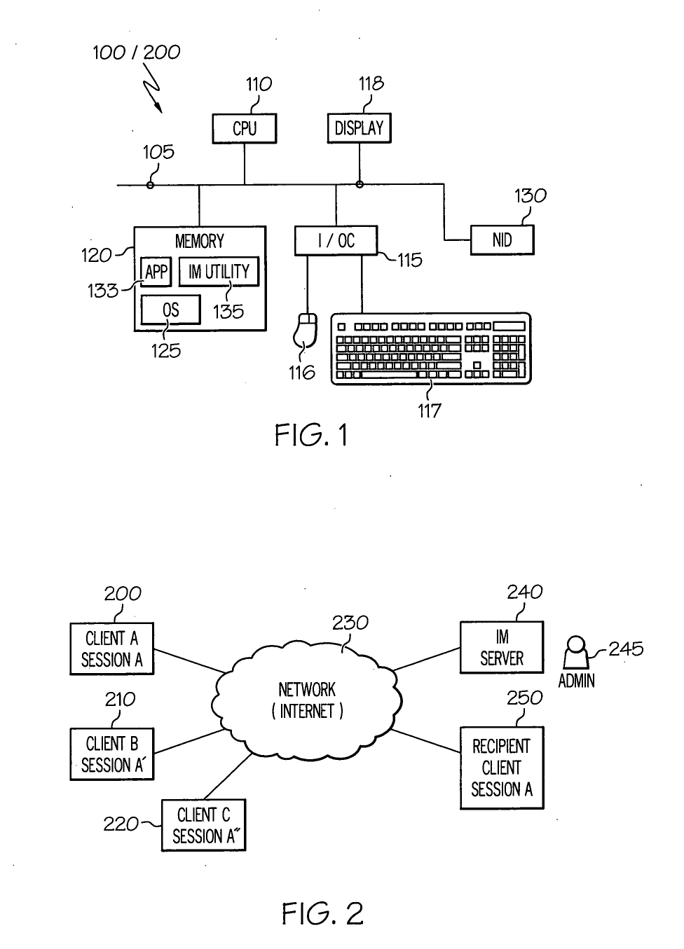

With reference now to the figures, and in particular to FIG. 1, there is depicted a computer system configured to enable various features of the invention, depending on the system's use as a primary client, secondary client or instant messenger (IM) server. Computer system 100 comprises processor 110 coupled to memory 120 and input/output (I/O) controller 115 via system bus 105. I/O controller 115 provides the connectivity to and/or control over input/output devices, including mouse 116, keyboard 117 and display device 118. Display device 118 may be one of a plurality of different types of display devices conventionally utilized by a computing device, and display device 118 provides a display screen, viewable by a user of the computing device.

Computer system 100 also comprises a network interface device 130 utilized to connect computer system 100 to another computer system and/or computer network (as illustrated by FIG. 2). NID 130 provides interconnectivity to an external network through a gateway or router, or other such device. NID 130 may be an Ethernet card or modem, for example, depending on the type of network to which the computer system 100 is connected.

Located within memory 120 and executed by processor 110 are a number of software components of which operating system (OS) 130 and a plurality of software applications 133, including instant messaging (IM) program/utility 135, are illustrated. Software applications 133 may also include network access applications/utilities and World Wide Web (or Internet) browser programs, among others. When executed by the processor, the OS 130 (e.g., Microsoft Windows®, a trademark of Microsoft Corp) enables the functionality by which the IM session GUI(s) generated by the IM utility 135 is displayed on a display screen (of the display device 418). According to the illustrative embodiment, OS 130, applications 133 (, and IM utility 135 execute on processor 110 to provide/enable IM functionality via an IM graphical user interface (GUIs) and background network access/routing features that are manifested to a user via the IM GUI displayed on display device 118.

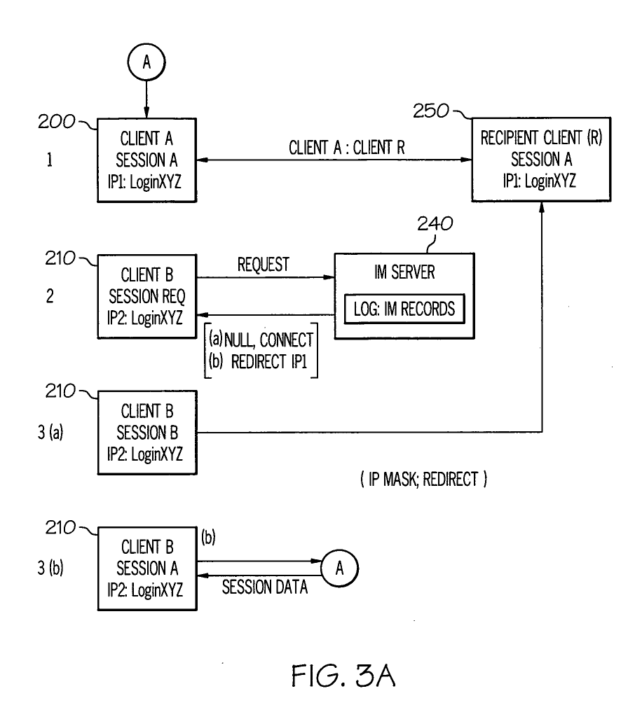

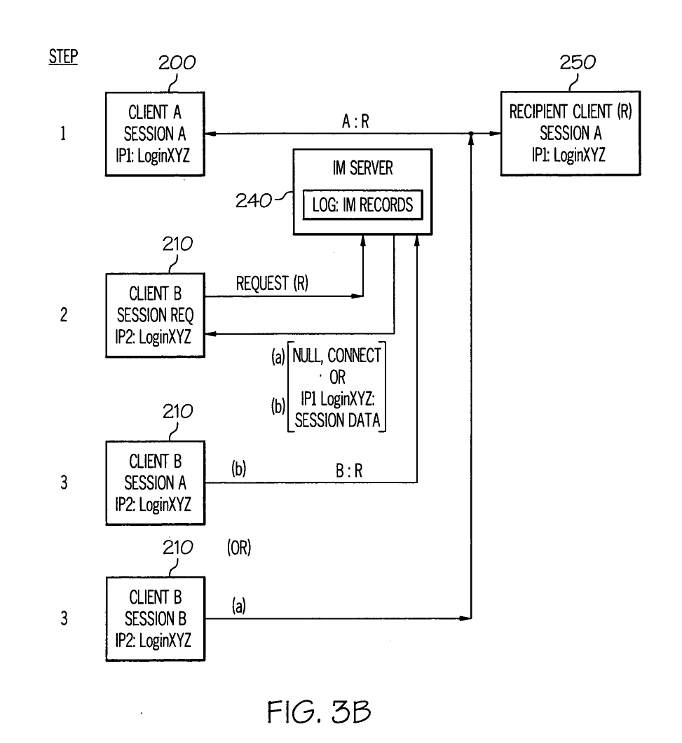

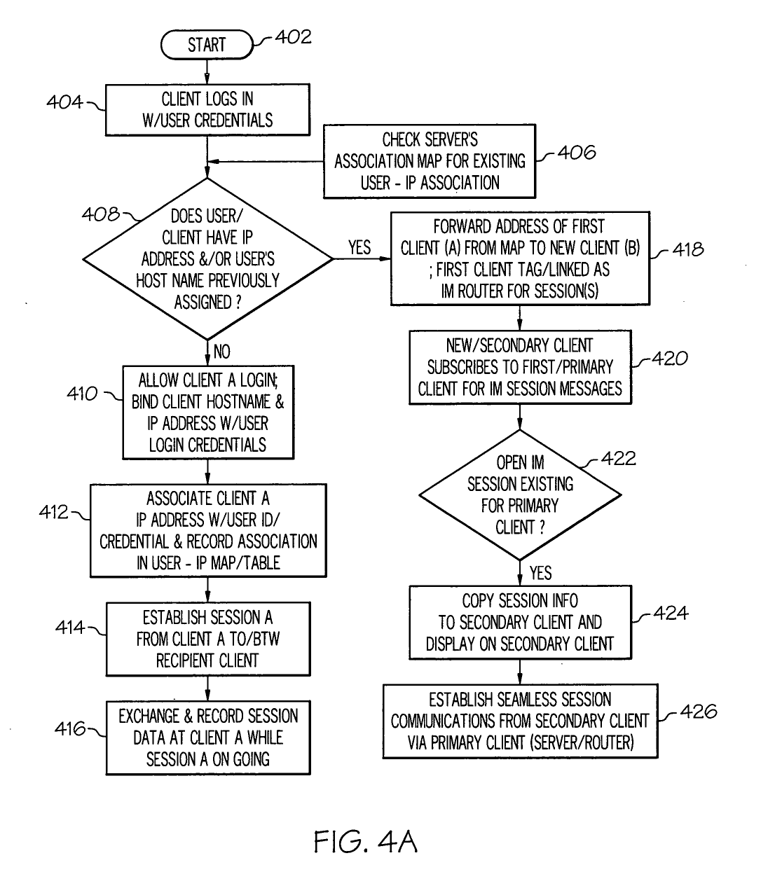

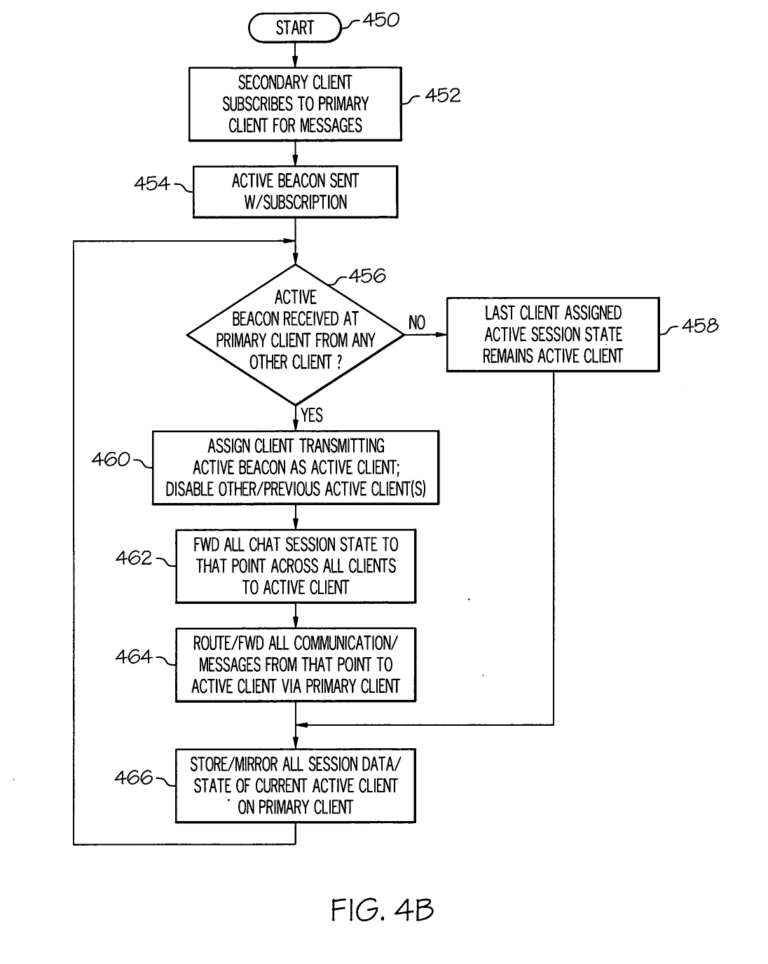

When executed by processor 110, IM utility 135 implements an enhanced IM program, which includes the subroutines that enable seamless continuation of IM sessions by a user across multiple clients, as described below. Computer system 100 may be utilized to provide IM server features, in which case computer system also comprises an IM session storage facility that records the IP address and user's login credentials (loginID and password) from a first client that initiates the user's IM session (referred to herein as the primary client). Alternatively, computer system 100 may be utilized as a client (primary or secondary) with IM utility 135 providing IM-router-type functionality for enabling client to operate (1) as an IM router to another secondary client that is currently active and (2) as a central repository for all continuing session data across multiple clients, as described below with reference to FIGS. 3A and 4A-4B.

In one embodiment, the hardware components of computer system 100 are of conventional design. Computer system 100 may also include other components (not shown) such as fixed disk drives, removable disk drives, CD and/or DVD drives, audio components, modems, network interface components, and the like. It will therefore be appreciated that the system described herein is illustrative and that variations and modifications are possible. Further, the techniques for IM server functionality may also be implemented in a variety of differently-configured computer systems. Thus, while the invention is describe as being implemented in computer system 100, those skilled in the art appreciate that various different configurations of computer systems exists and that the features of the invention are applicable regardless of the actual configuration of the computer system. Further, the invention is applicable to not only a desktop/laptop computer system but may also be implemented in a portable and/or hand held device such as a personal digital assistant (PDA), cell phone, or other hand-held devices, as well as within larger mainframe type devices, so long as the device has a display, network access, and an enhanced messaging utility, with similar functionality as IM utility 135.

With reference now to FIG. 2, there is illustrated an example network within which features of the invention may be advantageously implemented. Network 200 comprises a network backbone 230 illustrated as a network cloud. According to the described embodiments, network 200 is an Internet Protocol (IP) network (or Internet, for short) and transmits data packets (or segments) utilizing Transmission Control Protocol (TCP). Connected to network backbone 230 (via routers or gateways—not shown) are a plurality of client systems, of which clientA 200, clientB 210, and clientC 220 are illustrated. Client systems are computer devices that are utilized by a user to log into an IM application and enable an IM chat session. The IM session is enabled between a client system, e.g., clientA 200, and recipient client 250 via IM server 240. IM server 240 provides at least the general IM registration and support services across network 230, and in the illustrative embodiment, IM server 240 is maintained by an associated administrator 245.

Within the below described embodiments, clientA 200 represents the primary client (i.e., the client from which the first IM session is initiated, while clientB 210 and clientC 220 are secondary clients from which subsequent IM sessions continuing the first IM session initiated by the user. To distinguish among new IM sessions from the same user on different machines, each unique user-session is tagged with the same alpha character as its originating client (e.g., clientA—session A, clientB—session B); however, since the invention primarily enables seamless continuation of a single session (A) across multiple clients, sessions associated with later clients (e.g., clientB and clientC) are tagged as derivatives of the initial session (e.g., A′, A″).

Referring now to FIGS. 3A and 3B, there are sequence diagrams illustrating alternate embodiments of the implementation of the invention. In both illustrative embodiments, ClientA 200 is the primary client that establishes the initial IM session with recipient client (R) 250. This initial session is established through IM server 240 and links the user's session identified by the user's login ID (XYZ) to the IP address of clientA 200 (e.g., IP1:login XYZ, where IP1 is the IP address and XYZ represents the user's login credentials). ClientB 210 is the secondary IM client utilized by the user to either (1) continue an existing IM session from clientA 200 or (2) establish a new IM session. Thus, within the illustrative embodiment of FIG. 3A, the primary IM client 200 acts not only as an IM client but also as a router for the IM messages meant for the secondary client(s) 210.

FIG. 3B illustrates an alternate embodiment in which IM server 240 operates as the redirect-router (replacing primary client as the router for enabling seamless continuation of subsequent sessions from secondary clients. In a first implementation of this alternate embodiment, the IM server 240 retrieves copies of a session data from the primary client 200 and forwards that data to the secondary client 210. IM server 240 also links/masks the IP address of secondary client 210 to that of primary client 200 and redirects incoming messages from recipient client to the secondary client. In an another implementation (illustrated by sequence step 3(b) of FIG. 3B, IM utility of secondary client 210 masks the IP address of secondary client 210 with that of primary client 200 to enable direct routing of session data to recipient client 260. Meanwhile, IM server 240 masks IP2 as IP1 so that all response messages from recipient client are routed to secondary client. Notably, in alternate embodiments, the change of IP addresses may be completed at IM server or at secondary client. In both embodiments, IP2 is masked by IP1 within the header for all outgoing and incoming session data; however, the location at which the masking function occurs depends on the specific implementation.

Referring now to FIG. 4A, there is illustrated the process steps performed by the IM server within the sequence diagram of FIG. 3A. The process starts at initiation block 402, and then proceeds to block 404 at which the IM server 240 detects a client login with the user's login credentials. The IM server views each client login as a request to establish an IM session (as illustrated by sequence step 2 of FIG. 3A). Following an authentication of the user's login credentials, the IM server 240 checks the server's client IP-user loginID map/table of existing session associations, as indicated at block 406, and the IM server then determines, at decision block 408, whether there is a pre-assigned client IP address or hostname associated with the user login ID. If the IM server does not find any client IP address (or hostname) associated with the user login ID, the IM server tags the current client as a primary client for that loginID and binds the primary client hostname and IP address with the user login ID, as shown at block 410. This coincides with issuing a null response, as illustrated by sequence step 2(a) of FIG. 3A. The IM server then stores the association of the primary client's IP address and user login ID in a table maintained by the IM server, as depicted at block 412.

Once the above association is complete, the IM server enables the user to establish a chat session with a recipient client as shown at block 414. Session data/messages are exchanged between primary client and recipient client while the session is ongoing and, at block 416, a copy of the session data/messages is stored at the IM server (in a first embodiment) or the primary client (in a second embodiment).

Notably, this treatment of an initial login by a primary client and establishing a new session also corresponds to sequence step 3(a) (FIG. 3A/3B), which illustrates clientB 210 initiating a new session B directly with recipient client 250. Session B is directly routed between clients using the IP address of clientB 210, IP2, which is registered within IM server 240 as associated with user login ID XYZ. Thus, while the invention is described with clientA 200 as the primary client and clientB 210 as the secondary client, “primary” actually defines the first client from which the user establishes a current IM session, while “secondary” defines any subsequent client continuing the same IM session, before the current IM session terminates.

One embodiment utilizes the publish and subscribed messaging paradigm to enable the subsequent connection of a session from the secondary client when the primary client's IP address is associated/linked with the user loginID. With this mechanism, the above steps of registering clientA 200 as the primary client represents the publication by clientA 200 of its IP address as the IP address linked to any session involving the user loginID. That is, the IP address, IP1, is published to the server so that other clients may subscribe to the server and receive the published IP prior to establishing an IM session. Further, each secondary client subscribes to receive session data and other communication associated with the session from/via the primary client.

With this mechanism implemented within the process of FIG. 4A, and returning to decision block 408, if there is an existing entry at the IM server, the stored IP address of the primary client is retrieved and forwarded to the new client (secondary clientB) at block 418. Then, at block 420, the IM server alerts the secondary client that the primary client's IP address is assigned to any IM session associated with the particular user loginID, including an IM session conducted by/originating at the secondary client.

Assuming there is previous IM session data at the primary client, as determined at decision block 422, the primary client forwards the previous session data to the IM interface of the subscribed secondary client at block 424. Then, the primary client serves as an IM router to the secondary client, providing seamless session communication between the secondary client and the recipient client via the primary client and primary client IP address, as indicated at block 426. Sequence step 3(b) (FIG. 3A) illustrates the secondary clientB 210 continuing session A (as A′) via clientA 200. From the perspectives of clientB 210 and recipient client 250, session A′ is directly routed between clients. However, while clientB 210 transmits messages/session data with IP2 stored as the IP address within the header, those messages are transmitted to primary client 200, which replaces IP2 with its own IP address, IP1, prior to forwarding the session data to recipient client 250. Recipient client 250 thus sees the current session as merely a continuation of session A with clientA 200 having IP address IP1 and routes the session data with its recipient IP address attached in the header. Primary client 200 then forwards the recipient-provided session data to the specific secondary client 210 continuing the session.

One embodiment of the invention involves the use of active beacons within the publish-subscribed implementation. With this embodiment, when the user logs in from the secondary machine, the IM client on that secondary machine subscribes to the primary client for messages and sends an active beacon to the primary. From that point, all messages are routed to the secondary client. Thus, secondary clients subscribe to the primary when the user initially logs in at the secondary client and remain subscribed (in active or suspended mode). Thereafter, as soon as primary client registers/receives an active beacon from a secondary client, that secondary client is considered the active client, and each of the remaining subscribed clients is disabled (until one becomes active and sends an active beacon). This enables routing of messages to only the most recent active client.

The secondary clients thus indicate their change of status by sending beacons to the primary client. Along with state information such as active and away beacons, the secondary clients also send the chat history accumulated. This enables maintenance of session state by the clients across multiple machines.

After the user has logged into the primary and multiple secondary clients, an IM activity on any machine makes the client on that machine send an “active” beacon to the primary client. Also, where an active secondary client has been inactive for a preset period (e.g., 20 minutes) corresponding to the threshold for the away state, once that state is triggered on the active client, the active secondary client sends an “away” beacon to the primary client, and the primary client then sets the away message on the facade to the peer primary client. Notably, the away beacon is treated differently from an active beacon since the away beacon is transmitted from an already active client. In this embodiment, the state of the primary is thus the combined state of the user across all the machines on which the user has logged in, particularly the most recent active client. Other recipient IM users only see the state of the primary, which reflects the state of the most recent active client. Thus depending on beacons received from the secondary clients, the primary client is responsible for maintaining state information as well as routing of messages.

FIG. 4B is a flow chart of the process of seamlessly switching among clients utilizing receipt of activity beacons. The process starts at initiation block 450, following an initial log in to the IM server using the primary client, whereby all future IM session messages subsequently flow through the primary client. At block 452, a secondary client subscribes to the primary client and sends an active beacon along with the subscription, as shown at block 454. Primary client determines at decision block 456 whether an active beacon is received, and if not, the last client that transmitted an active beacon (if any) or the primary client remains the active client, as indicated at block 458.

If primary client receives an active beacon (e.g., when the user logs in from a different client machine or a different machine becomes active by registering some activity), primary client automatically assigns the different machine as the active secondary client, as shown at block 460. Contemporaneously, primary client suspends/disables any other, previously-assigned active client. Following, primary client forwards all recorded chat history associated with the IM session across the various clients (accumulated/recorded at primary client) to the active secondary client, as provided at block 462. Primary client then routes all communication/messages received from recipient client from that point to the active secondary client, as shown at block 464. As session data is generated/received by active secondary client, primary client captures and records a copy of the session data, as indicated at block 466. This record may then be passed to a next active client that sends an active beacon to the primary client. Thus, when a secondary client becomes active, while enabling the secondary client to become active, the primary client sends the chat session state to the active secondary client. Accordingly, any active IM client has the entire IM session state across all the machines up to that point in time.

The above described embodiments of the invention provide a solution to the problem of maintaining IM session state and facade maintenance among multiple clients for the same user. The invention finds applicability to environments in which the user may have to utilize multiple machines to complete the IM session. For example, a user may wish to continue a work-related session from his/her desktop at work to his/her laptop at home. With the added functionality of the invention, the user is now able to start an IM session with a recipient user in the office, commute to the user's home and login using his/her laptop/desktop at home and continue the same conversation without breaking the chat session, while receiving the historical information (i.e., exchanged messages) from the portion of the session that occurred at the office.

The invention enables the primary client to intelligently be made aware which IM client is active, route the messages accordingly and disable the rest of the clients. With this distributed approach to shared IM, the user is able to run IM as a service on all his workstations, and the user will only need to logout when a different user needs to start using IM on the same machine. The invention further allows maintenance of the same facade to the recipient user on the other side of the IM session irrespective of the machine/client the originating user is logged in from. This functional enhancement in IM technology may further permeate into existing IM suites.

It should be understood that at least some aspects of the present invention may alternatively be implemented in a computer-useable medium that contains a program product. Programs defining functions on the present invention can be delivered to a data storage system or a computer system via a variety of signal-bearing media, which include, without limitation, non-writable storage media (e.g., CD-ROM), writable storage media (e.g., a floppy diskette, hard disk drive, read/write CD ROM, optical media), and communication media, such as computer and telephone networks including Ethernet, the Internet, wireless networks, and like network systems. It should be understood, therefore, that such signal-bearing media when carrying or encoding computer readable instructions that direct method functions in the present invention, represent alternative embodiments of the present invention. Further, it is understood that the present invention may be implemented by a system having means in the form of hardware, software, or a combination of software and hardware as described herein or their equivalent.

Software Deployment

Thus, the method described herein, and in particular as shown and described in FIGS. 3A-4B can be deployed as a process-software from service provider server 240 to client computer 200.

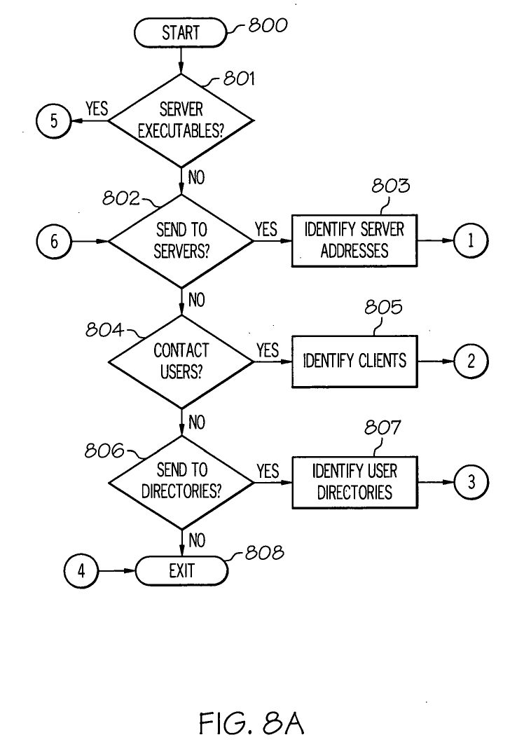

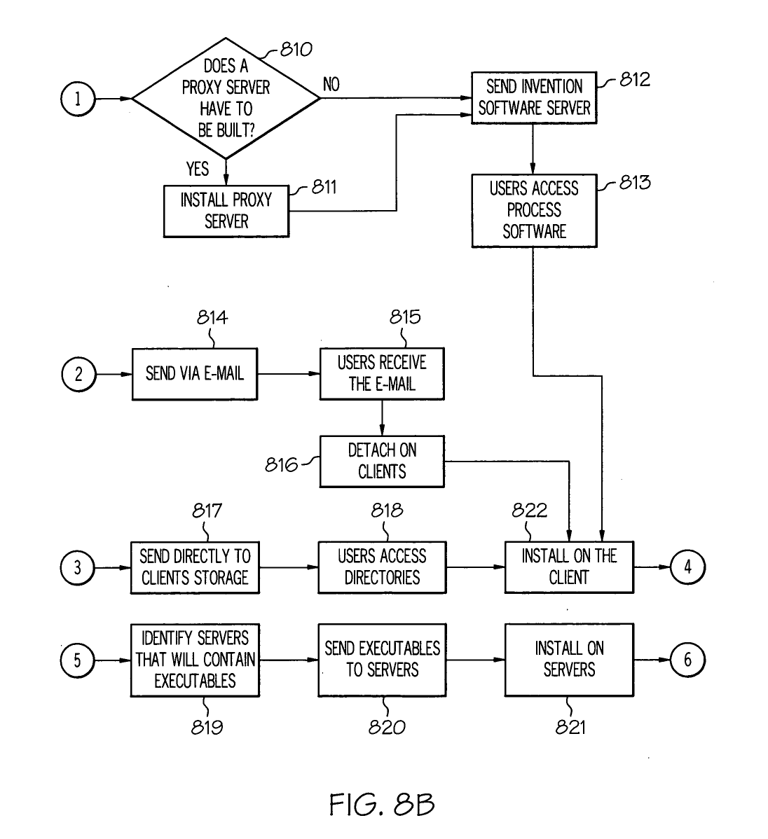

Referring then to FIG. 8, step 800 begins the deployment of the process software. The first thing is to determine if there are any programs that will reside on a server or servers when the process software is executed (query block 801). If this is the case, then the servers that will contain the executables are identified (block 819). The process software for the server or servers is transferred directly to the servers' storage via File Transfer Protocol (FTP) or some other protocol or by copying though the use of a shared file system (block 820). The process software is then installed on the servers (block 821).

Next, a determination is made on whether the process software is be deployed by having users access the process software on a server or servers (query block 802). If the users are to access the process software on servers, then the server addresses that will store the process software are identified (block 803).

A determination is made if a proxy server is to be built (query block 810) to store the process software. A proxy server is a server that sits between a client application, such as a Web browser, and a real server. It intercepts all requests to the real server to see if it can fulfill the requests itself. If not, it forwards the request to the real server. The two primary benefits of a proxy server are to improve performance and to filter requests. If a proxy server is required, then the proxy server is installed (block 811). The process software is sent to the servers either via a protocol such as FTP or it is copied directly from the source files to the server files via file sharing (block 812). Another embodiment would be to send a transaction to the servers that contained the process software and have the server process the transaction, then receive and copy the process software to the server's file system. Once the process software is stored at the servers, the users via their client computers, then access the process software on the servers and copy to their client computers file systems (block 813). Another embodiment is to have the servers automatically copy the process software to each client and then run the installation program for the process software at each client computer. The user executes the program that installs the process software on his client computer (block 822) then exits the process (terminator block 808).

In query step 804, a determination is made whether the process software is to be deployed by sending the process software to users via e-mail. The set of users where the process software will be deployed are identified together with the addresses of the user client computers (block 805). The process software is sent via e-mail to each of the users' client computers (block 814). The users then receive the e-mail (block 815) and then detach the process software from the e-mail to a directory on their client computers (block 816). The user executes the program that installs the process software on his client computer (block 822) then exits the process (terminator block 808).

Lastly a determination is made on whether to the process software will be sent directly to user directories on their client computers (query block 806). If so, the user directories are identified (block 807). The process software is transferred directly to the user's client computer directory (block 817). This can be done in several ways such as but not limited to sharing of the file system directories and then copying from the sender's file system to the recipient user's file system or alternatively using a transfer protocol such as File Transfer Protocol (FTP). The users access the directories on their client file systems in preparation for installing the process software (block 818). The user executes the program that installs the process software on his client computer (block 822) and then exits the process (terminator block 808).

VPN Deployment

The present software can be deployed to third parties as part of a service wherein a third party VPN service is offered as a secure deployment vehicle or wherein a VPN is built on-demand as required for a specific deployment.

A virtual private network (VPN) is any combination of technologies that can be used to secure a connection through an otherwise unsecured or untrusted network. VPNs improve security and reduce operational costs. The VPN makes use of a public network, usually the Internet, to connect remote sites or users together. Instead of using a dedicated, real-world connection such as leased line, the VPN uses “virtual” connections routed through the Internet from the company's private network to the remote site or employee. Access to the software via a VPN can be provided as a service by specifically constructing the VPN for purposes of delivery or execution of the process software (i.e. the software resides elsewhere) wherein the lifetime of the VPN is limited to a given period of time or a given number of deployments based on an amount paid.

The process software may be deployed, accessed and executed through either a remote-access or a site-to-site VPN. When using the remote-access VPNs the process software is deployed, accessed and executed via the secure, encrypted connections between a company's private network and remote users through a third-party service provider. The enterprise service provider (ESP) sets a network access server (NAS) and provides the remote users with desktop client software for their computers. The telecommuters can then dial a toll-bee number or attach directly via a cable or DSL modem to reach the NAS and use their VPN client software to access the corporate network and to access, download and execute the process software.

When using the site-to-site VPN, the process software is deployed, accessed and executed through the use of dedicated equipment and large-scale encryption that are used to connect a companies multiple fixed sites over a public network such as the Internet.

The process software is transported over the VPN via tunneling which is the process the of placing an entire packet within another packet and sending it over a network. The protocol of the outer packet is understood by the network and both points, called runnel interfaces, where the packet enters and exits the network.

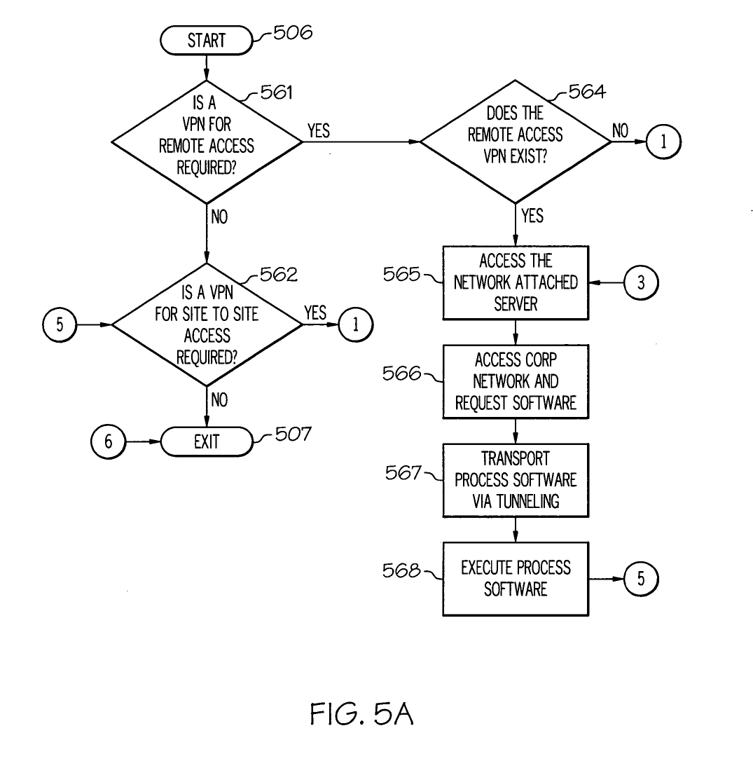

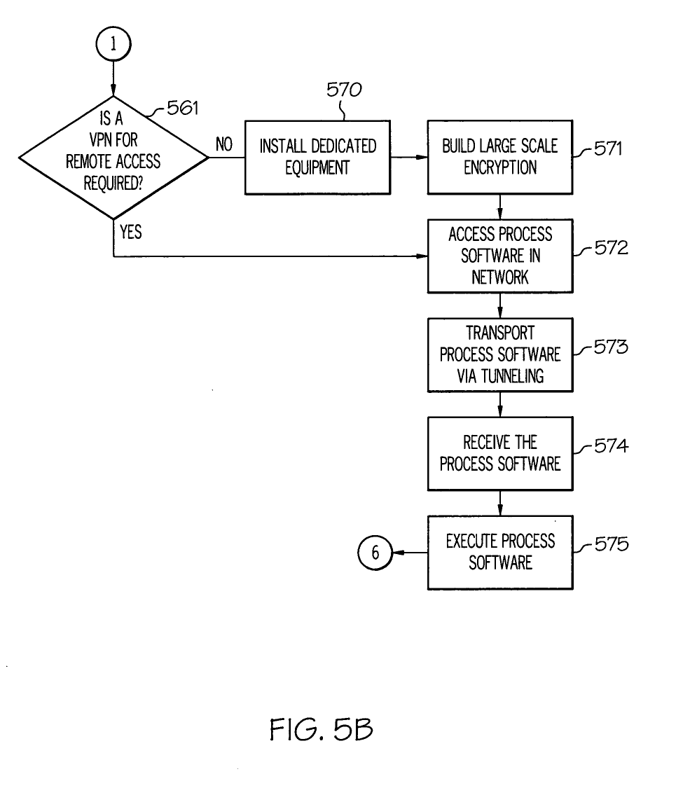

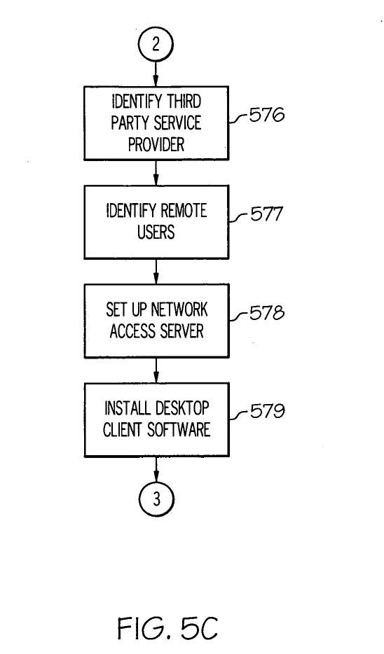

The process for such VPN deployment is described in FIG. 5. Initiator block 506 begins the Virtual Private Network (VPN) process. A determination is made to see if a VPN for remote access is required (query block 561). If it is not required, then proceed to (query block 562). If it is required, then determine if the remote access VPN exists (query block 564).

If a VPN does exist, then proceed to block 565. Otherwise identify a third party provider that will provide the secure, encrypted connections between the company's private network and the company's remote users (block 576). The company's remote users are identified (block 577). The third party provider then sets up a network access server (NAS) (block 578) that allows the remote users to dial a toll free number or attach directly via a broadband modem to access, download and install the desktop client software for the remote-access VPN (block 579).

After the remote access VPN has been built or if it been previously installed, the remote users can access the process software by dialing into the NAS or attaching directly via a cable or DSL modem into the NAS (block 565). This allows entry into the corporate network where the process software is accessed (block 566). The process software is transported to the remote user's desktop over the network via tunneling (block 567). That is, the process software is divided into packets and each packet including the data and protocol is placed within another packet (block 567). When the process software arrives at the remote user's desk-top, it is removed from the packets, reconstituted and then is executed on the remote user's desk-top (block 568).

A determination is then made to see if a VPN for site to site access is required (query block 562). If it is not required, then proceed to exit the process (terminator block 507). Otherwise, determine if the site to site VPN exists (query block 561). If it does exist, then proceed to block 572. Otherwise, install the dedicated equipment required to establish a site to site VPN (block 570). Then build the large scale encryption into the VPN (block 571).

After the site to site VPN has been built or if it had been previously established, the users access the process software via the VPN (block 572). The process software is transported to the site users over the network via tunneling (block 573). That is the process software is divided into packets and each packet including the data and protocol is placed within another packet (block 574). When the process software arrives at the remote user's desktop, it is removed from the packets, reconstituted and is executed on the site user's desk-top (block 575). The process then ends at terminator block 507.

Software Integration

The process software which consists code for implementing the process described herein may be integrated into a client, server and network environment by providing for the process software to coexist with applications, operating systems and network operating systems software and then installing the process software on the clients and servers in the environment where the process software will function.

The first step is to identify any software on the clients and servers including the network operating system where the process software will be deployed that are required by the process software or that work in conjunction with the process software. This includes the network operating system that is software that enhances a basic operating system by adding networking features.

Next, the software applications and version numbers will be identified and compared to the list of software applications and version numbers that have been tested to work with the process software. Those software applications that are missing or that do not match the correct version will be upgraded with the correct version numbers. Program instructions that pass parameters from the process software to the software applications will be checked to ensure the parameter lists matches the parameter lists required by the process software. Conversely parameters passed by the software applications to the process software will be checked to ensure the parameters match the parameters required by the process software. The client and server operating systems including the network operating systems will be identified and compared to the list of operating systems, version numbers and network software that have been tested to work with the process software. Those operating systems, version numbers and network software that do not match the list of tested operating systems and version numbers will be upgraded on the clients and servers to the required level.

After ensuring that the software, where the process software is to be deployed, is at the correct version level that has been tested to work with the process software, the integration is completed by installing the process software on the clients and servers.

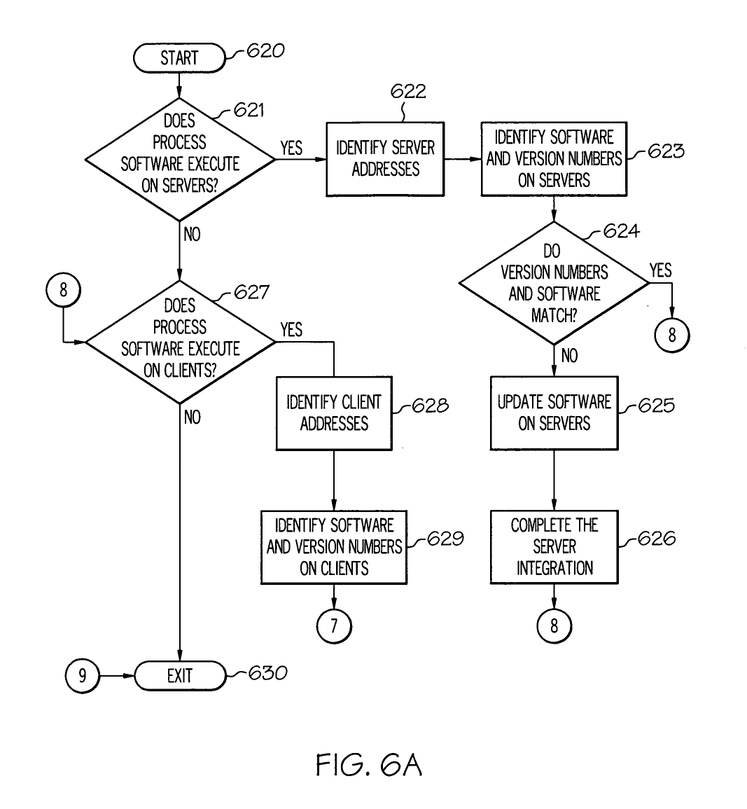

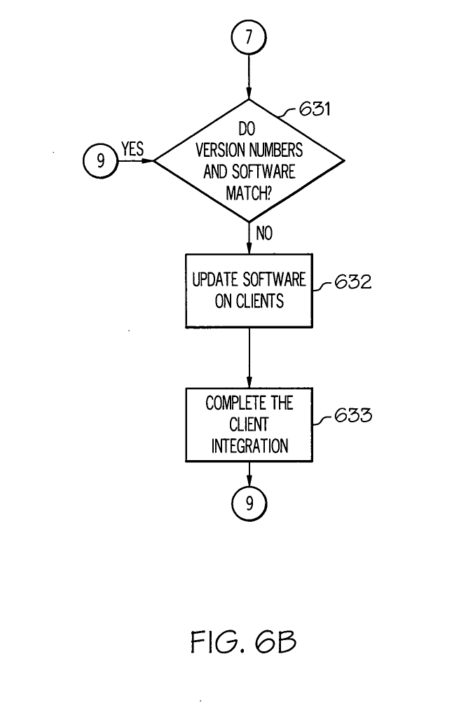

For a high-level description of this process, reference is now made to FIG. 6. Initiator block 620 begins the integration of the process software. The first tiling is to determine if there are any process software programs that will execute on a server or servers (block 621). If this is not the case, then integration proceeds to query block 627. If this is the case, then the server addresses are identified (block 622). The servers are checked to see if they contain software that includes the operating system (OS), applications, and network operating systems (NOS), together with their version numbers, which have been tested with the process software (block 623). The servers are also checked to determine if there is any missing software that is required by the process software in block 610.

A determination is made if the version numbers match the version numbers of OS, applications and NOS that have been tested with the process software (block 624). If all of the versions match and there is no missing required software the integration continues in query block 627.

If one or more of the version numbers do not match, then the unmatched versions are updated on the server or servers with the correct versions (block 625). Additionally, if there is missing required software, then it is updated on the server or servers in the step shown in block 614. The server integration is completed by installing the process software (block 626).

The step shown in query block 627, which follows either the steps shown in block 621, 624 or 626 determines if there are any programs of the process software that will execute on the clients. If no process software programs execute on the clients the integration proceeds to terminator block 630 and exits. If this not the case, then the client addresses are identified as shown in block 628.

The clients are checked to see if they contain software that includes the operating system (OS), applications, and network operating systems (NOS), together with their version numbers, which have been tested with the process software (block 629). The clients are also checked to determine if there is any missing software that is required by the process software in the step described by block 622.

A determination is made is the version numbers match the version numbers of OS, applications and NOS that have been tested with the process software (query block 631). If all of the versions match and there is no missing required software, then the integration proceeds to terminator block 630 and exits.

If one or more of the version numbers do not match, then the unmatched versions are updated on the clients with the correct versions (block 632). In addition, if there is missing required software then it is updated on the clients (also block 626). The client integration is completed by installing the process software on the clients (block 633). The integration proceeds to terminator block 630 and exits.

On Demand

The process software is shared, simultaneously serving multiple customers in a flexible, automated fashion. It is standardized, requiring little customization and it is scalable, providing capacity on demand in a pay-as-you-go model.

The process software can be stored on a shared file system accessible from one or more servers. The process software is executed via transactions that contain data and server processing requests that use CPU units on the accessed server. CPU units are units of time such as minutes, seconds, hours on the central processor of the server. Additionally the assessed server may make requests of other servers that require CPU units. CPU units are an example that represents but one measurement of use. Other measurements of use include but are not limited to network bandwidth, memory usage, storage usage, packet transfers, complete transactions etc.

When multiple customers use the same process software application, their transactions are differentiated by the parameters included in the transactions that identify the unique customer and the type of service for that customer. All of the CPU units and other measurements of use that are used for the services for each customer are recorded. When the number of transactions to any one server reaches a number that begins to affect the performance of that server, other servers are accessed to increase the capacity and to share the workload. Likewise when other measurements of use such as network bandwidth, memory usage, storage usage, etc. approach a capacity so as to affect performance, additional network bandwidth, memory usage, storage etc. are added to share the workload.

The measurements of use used for each service and customer are sent to a collecting server that sums the measurements of use for each customer for each service that was processed anywhere in the network of servers that provide the shared execution of the process software. The summed measurements of use units are periodically multiplied by unit costs and the resulting total process software application service costs are alternatively sent to the customer and or indicated on a web site accessed by the customer which then remits payment to the service provider.

In another embodiment, the service provider requests payment directly from a customer account at a banking or financial institution.

In another embodiment, if the service provider is also a customer of the customer that uses the process software application, the payment owed to the service provider is reconciled to the payment owed by the service provider to minimize the transfer of payments.

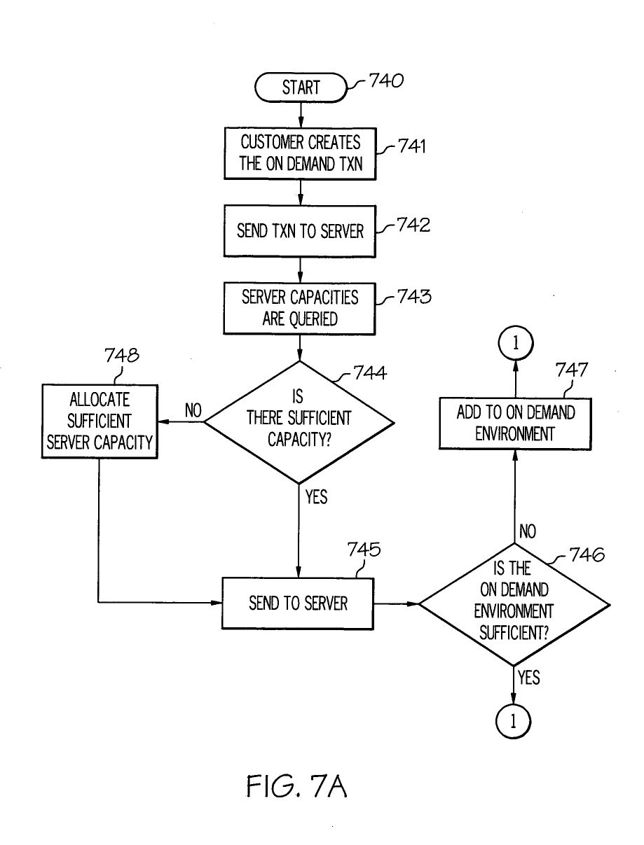

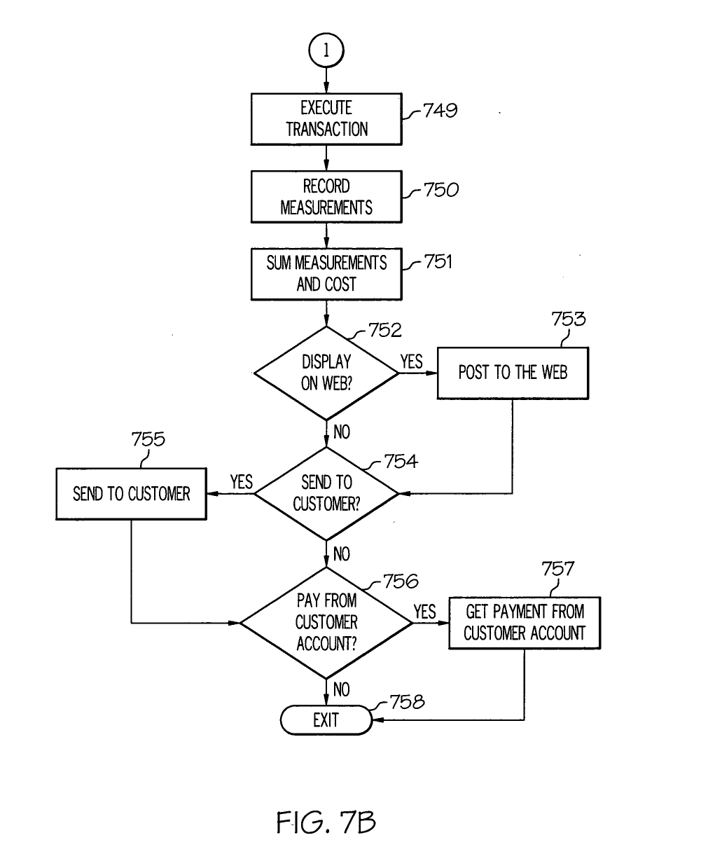

With reference now to FIG. 7, initiator block 740 begins the On Demand process. A transaction is created than contains the unique customer identification, the requested service type any service parameters that further, specify the type of service (block 741). The transaction is then sent to the main server (block 742). In an On Demand environment the main server can initially be the only server, then as capacity is consumed other servers are added to the On Demand environment.

The server central processing unit (CPU) capacities in the On Demand environment are queried (block 743). The CPU requirement of the transaction is estimated, then the servers available CPU capacity in the On Demand environment are compared to the transaction CPU requirement to see if there is sufficient CPU available capacity in any server to process the transaction (query block 744). If there is not sufficient server CPU available capacity, then additional server CPU capacity is allocated to process the transaction (block 748). If there was already sufficient Available CPU capacity then the transaction is sent to a selected server (block 745).

Before executing the transaction, a check is made of the remaining On Demand environment to determine if the environment has sufficient available capacity for processing the transaction. This environment capacity consists of such things as but not limited to network bandwidth, processor memory, storage etc. (block 746). If there is not sufficient available capacity, then capacity will be added to the On Demand environment (block 747). Next the required software to process the transaction is accessed, loaded into memory, then the transaction is executed (block 749).

The usage measurements are recorded (block 750). The usage measurements consist of the portions of those functions in the On Demand environment that are used to process the transaction. The usage of such functions as, but not limited to, network bandwidth, processor memory, storage and CPU cycles are what is recorded. The usage measurements are summed, multiplied by unit costs and then recorded as a charge to the requesting customer (block 751).

If the customer has requested that the On Demand costs be posted to a web site (query block 752), then they are posted (block 753). If the customer has requested that the On Demand costs be sent via e-mail to a customer address (query block 754), then these costs are sent to the customer (block 755). If the customer has requested that the On Demand costs be paid directly from a customer account (query block 756), then payment is received directly from the customer account (block 757). The On Demand process is then exited at terminator block 758.

While the present invention has been particularly shown and described with reference to a preferred embodiment, it will be understood by those skilled in the art that various changes in form and detail may be made therein without departing from the spirit and scope of the invention. Furthermore, as used in the specification and the appended claims, the term “computer” or “system” or “computer system” or “computing device” includes any data processing system including, but not limited to, personal computers, servers, workstations, network computers, main frame computers, routers, switches, Personal Digital Assistants (PDA's), telephones, and any other system capable of processing, transmitting, receiving, capturing and/or storing data.

As a final matter, it is important that while an illustrative embodiment of the present invention has been, and will continue to be, described in the context of a fully functional computer system with installed management software, those skilled in the art will appreciate that the software aspects of an illustrative embodiment of the present invention are capable of being distributed as a program product in a variety of forms, and that an illustrative embodiment of the present invention applies equally regardless of the particular type of signal bearing media used to actually carry out the distribution. Examples of signal bearing media include recordable type media such as floppy disks, hard disk drives, CD ROMs, and transmission type media such as digital and analogue communication links.

What is claimed is:

1. In a computing environment having multiple client devices, each configured with an Instant messaging (IM) utility, a computer-implementable method comprising:
establishing a first IM session with a first user login identifier (ID) on a first client device that has an associated first network routing address; and
when a request to establish a next IM session with the same first user login ID is received from a second client device while the first IM session is active, dynamically enabling a seamless continuation of the first IM session on the second client device.

2. The method of claim 1, wherein the dynamically enabling further comprises:
retrieving session data and information from the first IM session and network routing information from the first client device;
providing the session data and information and the first client device's network routing information to the second client device from which the request for the next IM session originated; and
enabling the second terminal to establish a seamless connection between an IM session initiated at the second client device and the first IM session utilizing the session data and information and the network routing information.

3. The method of claim 1, further comprising:
recording chat session data of a chat session between the first user login ID and a recipient user login ID; and
forwarding the chat session data to the second client device when the seamless connection is completed, whereby an IM session on the second client device displays a history of the chat session data recorded at the first client device.

4. The method of claim 1, further comprising establishing an IM server function that performs the functions of:
monitoring for entry of the first user login ID across the multiple client devices to initiate a new IM session;
determining whether a client requesting initiation of the new IM session provides a user login ID that is currently associated with another client's host name and IP address for an active IM session; and
when no other client's host name and IP address are currently associated with the user login ID, binding the hostname and IP address of the requesting client with the user login ID, wherein the requesting client becomes a primary client for completing IM session communication for that user login ID.

5. The method of claim 4, further comprising:
when a next user login request is detected from a second IM client device, comparing the login ID of the request against a map of active user login IDs that are bound to specific hostnames and IP addresses of primary clients; and
when a match of the login ID is found in the map of active user login IDs:
retrieving the hostname and IO address of the primary client bound to the login ID; and
subsequently enabling the IM session on the primary client to be continued on the second IM client device and routing all communication during the IM session via the primary device, which stores a record of all transactions occurring during the IM session for forwarding during a next seamless transfer of the IM session across client devices.

6. The method of claim 1, wherein said dynamically enabling comprises:
publishing the first client device as a primary client device for handling all requests for an IM session associated with the user login ID;
enabling other secondary client devices to subscribe to the primary client device for completing subsequent IM session transactions by the user;
maintaining a record of all IM session data across all client devices including the primary client device and secondary client devices that are subscribed to the primary client device;
receiving an active beacon whenever an activity is registered on a secondary client device;
responsive to the receipt of the active beacon, automatically forwarding the record to the active secondary client device issuing the active beacon and enabling the active secondary client device to complete seamless transactions via the open IM session; and
providing current session state of the IM session within a façade of the primary client device, wherein a session state at an active secondary client device is reflected as the session state of the primary client device.

7. A system comprising:
a processor;
a data bus coupled to the processor;
a memory coupled to the data bus; and
a computer-usable medium embodying computer program code, the computer program code comprising instructions executable by the processor and configured to:
establish a first IM session with a first user login identifier (ID) on a first client device that has an associated first network routing address; and
when a request to establish a next IM session with the same first user login ID is received from a second client device while the first IM session is active, dynamically enable a seamless continuation of the first IM session on the second client device.

8. The system of claim 7, wherein the instructions are further configured to:
retrieve session data and information from the first IM session and network routing information from the first client device;
provide the session data and information and the first client device's network routing information to the second client device from which the request for the next IM session originated; and
enable the second terminal to establish a seamless connection between an IM session initiated at the second client device and the first IM session utilizing the session data and information and the network routing information.

9. The system of claim 7, wherein the instructions are further configured to:
record chat session data of a chat session between the first user login ID and a recipient user login ID; and
forward the chat session data to the second client device when the seamless connection is completed, whereby an IM session on the second client device displays a history of the chat session data recorded at the first client device.

10. The system of claim 7, wherein the instructions to dynamically enable are further configured to establish an IM server function that performs the functions of:
monitoring for entry of the first user login ID across the multiple client devices to initiate a new IM session;
determining whether a client requesting initiation of the new IM session provides a user login ID that is currently associated with another client's host name and IP address for an active IM session; and
when no other client's host name and IP address are currently associated with the user login ID, binding the hostname and IP address of the requesting client with the user login ID, wherein the requesting client becomes a primary client for completing IM session communication for that user login ID.

11. The system of claim 10, wherein the instructions are further configured to:
when a next user login request is detected from a second IM client device, compare the login ID of the request against a map of active user login IDs that are bound to specific hostnames and IP addresses of primary clients; and
when a match of the login ID is found in the map of active user login IDs:
retrieve the hostname and IO address of the primary client bound to the login ID; and
subsequently enable the IM session on the primary client to be continued on the second IM client device and routing all communication during the IM session via the primary device, which stores a record of all transactions occurring during the IM session for forwarding during a next seamless transfer of the IM session across client devices.

12. The system of claim 7, wherein the instructions to dynamically enable are further configured to:
publish the first client device as a primary client device for handling all requests for an IM session associated with the user login ID;
enable other secondary client devices to subscribe to the primary client device for completing subsequent IM session transactions by the user;
maintain a record of all IM session data across all client devices including the primary client device and secondary client devices that are subscribed to the primary client device;
receive an active beacon whenever an activity is registered on a secondary client device;
responsive to the receipt of the active beacon, automatically forward the record to the active secondary client device issuing the active beacon and enabling the active secondary client device to complete seamless transactions via the open IM session; and
provide current session state of the IM session within a façade of the primary client device, wherein a session state at an active secondary client device is reflected as the session state of the primary client device.

13. A computer-usable medium embodying computer program code, the computer program code comprising computer executable instructions configured to:
establish a first IM session with a first user login identifier (ID) on a first client device that has an associated first network routing address; and
when a request to establish a next IM session with the same first user login ID is received from a second client device while the first IM session is active, dynamically enable a seamless continuation of the first IM session on the second client device.

14. The computer-usable medium of claim 13, wherein the embodied computer program code further comprises computer executable instructions configured to:
retrieve session data and information from the first IM session and network routing information from the first client device;
provide the session data and information and the first client device's network routing information to the second client device from which the request for the next IM session originated; and
enable the second terminal to establish a seamless connection between an IM session initiated at the second client device and the first IM session utilizing the session data and information and the network routing information.

15. The computer-usable medium of claim 13, wherein the embodied computer program code further comprises computer executable instructions configured to:
record chat session data of a chat session between the first user login ID and a recipient user login ID; and
forward the chat session data to the second client device when the seamless connection is completed, whereby an IM session on the second client device displays a history of the chat session data recorded at the first client device.

16. The computer-usable medium of claim 13, wherein the embodied computer program code further comprises computer executable instructions configured to establish an IM server function and performs the functions of:
monitoring for entry of the first user login ID across the multiple client devices to initiate a new IM session;
determining whether a client requesting initiation of the new IM session provides a user login ID that is currently associated with another client's host name and IP address for an active IM session; and
when no other client's host name and IP address are currently associated with the user login ID, binding the hostname and IP address of the requesting client with the user login ID, wherein the requesting client becomes a primary client for completing IM session communication for that user login ID.

17. The computer-usable medium of claim 16, wherein the embodied computer program code further comprises computer executable instructions configured to:
when a next user login request is detected from a second IM client device, compare the login ID of the request against a map of active user login IDs that are bound to specific hostnames and IP addresses of primary clients; and
when a match of the login ID is found in the map of active user login IDs:
retrieve the hostname and IO address of the primary client bound to the login ID; and
subsequently enable the IM session on the primary client to be continued on the second IM client device and routing all communication during the IM session via the primary device, which stores a record of all transactions occurring during the IM session for forwarding during a next seamless transfer of the IM session across client devices.

18. The computer-usable medium of claim 13, wherein the embodied computer program code further comprises computer executable instructions configured to:
publish the first client device as a primary client device for handling all requests for an IM session associated with the user login ID;
enable other secondary client devices to subscribe to the primary client device for completing subsequent IM session transactions by the user;
maintain a record of all IM session data across all client devices including the primary client device and secondary client devices that are subscribed to the primary client device;
receive an active beacon whenever an activity is registered on a secondary client device;
responsive to the receipt of the active beacon, automatically forward the record to the active secondary client device issuing the active beacon and enabling the active secondary client device to complete seamless transactions via the open IM session; and
provide current session state of the IM session within a façade of the primary client device, wherein a session state at an active secondary client device is reflected as the session state of the primary client device.

19. The computer-useable medium of claim 13, wherein the computer executable instructions are deployable to a client computer from a server at a remote location.

20. The computer-useable medium of claim 13, wherein the computer executable instructions are provided by a service provider to a customer on an on-demand basis.
